(19) United States
(12) Patent Application Publication
(10) Pub. No.: US 2018/0152475 A1
(43) Pub. Date: May 31, 2018

(54) DDOS ATTACK DETECTION SYSTEM BASED ON SVM-SOM COMBINATION AND METHOD THEREOF

(71) Applicant: Foundation of Soongsil University-Industry Cooperation, Seoul (KR)

(72) Inventors: Min Ho Park, Seoul (KR); Young Pin Kim, Seoul (KR); Trung Van Phan, Seoul (KR)

(21) Appl. No.: 15/823,774

(22) Filed: Nov. 28, 2017

(30) Foreign Application Priority Data
Nov. 30, 2016 (KR) 10-2016-0161099
Apr. 5, 2017 (KR) 10-2017-0044402

(51) Int. Cl. H04L 29/06; G06N 3/08; H04L 12/26; H04L 12/851

(52) U.S. Cl. CPC H04L 63/1458; H04L 63/1416; H04L 63/1425; H04L 47/2441; H04L 63/20; H04L 43/022; G06N 3/088

(57) ABSTRACT

Provided are an OpenFlow controller that performs DDoS attack detection based on SVM-SOM combination in a software-defined network and a method thereof. The OpenFlow controller collects flow information from multiple OpenFlow switches, extracts predetermined multiple attributes from a flow, classifies a traffic type of the flow on the basis of the extracted attributes, classifies an attack flow on the basis of one or more first attributes among the extracted attributes through an SVM corresponding to the classified traffic type among multiple linear SVMs, and determines whether a flow which is not classified as an attack flow by the SVM is a suspicious pattern through a SOM on the basis of second attributes greater in number than the first attributes among the extracted attributes, and classifies an attack type of the flow classified as an attack flow by the SVM or determined as a suspicious pattern by the SOM.

### CROSS-REFERENCE TO RELATED APPLICATION

This application claims the benefit under 35 USC 119(a) of Korean Patent Application No. 10-2016-0161099 filed on Nov. 30, 2016, and Korean Patent Application No. 10-2017-0044402 filed on Apr. 5, 2017, in the Korean Intellectual Property Office, the entire disclosures of which are incorporated herein by reference for all purposes.

### TECHNICAL FIELD

The present disclosure relates to a system and method for detecting a distributed denial of service (DDoS) attack.

### BACKGROUND

Recently, software-defined networking (SDN) technology has been researched as a promising next-generation network technology. In a SND model, a control plane and a data plane are separated, and, thus, a number of benefits are provided in terms of network monitoring and control.

An OpenFlow controller, which is the center of the SDN technology, is a type of SDN controller that uses an OpenFlow protocol. The OpenFlow protocol is a standard communication interface defined between a control plane and a data plane in the SDN, and enables direct control of packet transmission of network devices such as a switch or a router. The OpenFlow controller controls and monitors flow-based traffic between network devices (routers, switches, etc.) through an OpenFlow switch. Thus, if the controller calculates and sets a route of the flow and then transmits it to the switch, the switch performs only forwarding. This feature of the SDN is a great advantage in terms of network management, but may become a weakness in terms of security such as DDoS detection.

A DDoS refers to an action that botnets generates a massive flow and transmits it to a victim server. The reason why the OpenFlow is vulnerable to such a DDoS is that the OpenFlow switch can usually maintain up to a million flows. That is, if the SDN comes under DDoS and a number of flows are sent to the OpenFlow switch, a target server or network becomes a victim of the attack and the OpenFlow controller or OpenFlow switch also has a risk of stopping working due to depletion of resources.

Therefore, accurately distinguishing whether traffic is normal or DDoS traffic in a SDN environment is definitely necessary to suppress DDoS.

Conventionally, AVANT-GUARD for overcoming bottleneck problems caused by an access move tool in the SDN environment, a proactive flow rule analyzer and packet migration of Flood Guard for guarding the enforcement of network policies and protecting a SDN controller, Fuzzy Logic applied to defense against flooding attacks in the SDN and Fonseca environments, “ident++ protocol” as an effective response to saturation attacks for a SDN controller, Barga technique relevant to DDoS mechanism using a SOM (Self-Organizing Map), a DDoS Blocking Scheme dealing with botnet-based attacks using a standard OpenFlow interface, and the like have been suggested. These mechanisms are configured with the purpose of DDoS and network protection.

In this regard, Korean Patent No. 10-0950582 (entitled “Method and apparatus of detecting traffic flooding attack using support vector data description and recording medium thereof) discloses a method of detecting a traffic flooding attack using a support vector data description, including: performing complete enumeration by applying a traffic flooding attack tool among a set of management information bases; extracting a management information base responding to the traffic flooding attack of the traffic flooding attack tool; predicting a next update interval for management information base using an already measured update interval for information of the extracted management information base and collecting information of the management information base at the predicted update interval for management information base; detecting whether there is a traffic flooding attack by analyzing the collected information of the management information base using a support vector data description (SVDD) of a support vector machine (SVM); and if there is a traffic flooding attack, classifying a type of the traffic flooding attack on the basis of the support vector data description.

However, a conventional SVM can classify a flow with high speed but very low accuracy, and a SOM has high accuracy but low computation speed and requires a lot of resources.

### SUMMARY

In view of the foregoing, the present disclosure provides a DDoS attack detection system based on SVM-SOM combination which is capable of effectively detecting and suppressing a DDoS attack using a system with an SVM and a SOM configured to classify traffic with high accuracy in order to detect and suppress a DDoS in a SDN environment, and a method thereof.

However, problems to be solved by the present disclosure are not limited to the above-described problems. There may be other problems to be solved by the present disclosure.

According to an aspect of the present disclosure, an OpenFlow controller that performs DDoS attack detection based on SVM-SOM combination includes: a flow collector configured to collect flow information from multiple OpenFlow switches; a feature extractor configured to extract predetermined multiple attributes from a flow corresponding to the flow information; a traffic classifier configured to classify a traffic type of the flow on the basis of the attributes and transmit the flow to an SVM module corresponding to the classified traffic type; an SVM module configured to classify an attack flow on the basis of one or more first attributes among the extracted attributes with respect to the flow input according to the traffic type, determine an area on the basis of a position of the input flow on Support Vector Machine representation according to a result of learning of normal and abnormal sample data, and transmit the flow to an attack classifier if the determined area is included an area of an attack flow or transmit the flow to a SOM module if the determined area is included an uncertain area; a SOM module configured to determine whether the flow input from the SVM module is a suspicious pattern on the basis of second attributes greater in number than the first attributes among the extracted attributes and determine whether there is a suspicious pattern with respect to an input vector of the flow input from the SVM module on a SOM; and an attack classifier configured to classify the flow, which is classified as a clear attack flow by the SVM module or determined as a suspicious pattern by the SOM module, as one of predetermined attack types.

According to another aspect of the present disclosure, a method of DDoS attack detection based on SVM-SOM combination by an OpenFlow controller includes: collecting flow information from multiple OpenFlow switches; extracting predetermined multiple attributes from a flow corresponding the flow information; classifying a traffic type of the flow on the basis of the extracted attributes; classifying the flow as an attack flow through an SVM on the basis of one or more first attributes among the extracted attributes of the flow; determining the flow as a suspicious pattern through a SOM on the basis of second attributes greater in number than the first attributes among the extracted attributes of the flow if the flow is not classified as an attack flow; and classifying an attack type of the flow as one of predetermined attack types if the flow is classified as a clear attack flow by the SVM or determined as a suspicious pattern by the SOM, wherein the step of classifying the flow as an attack flow is performed through an SVM corresponding to the classified traffic type among multiple linear SVMs corresponding to predetermined multiple traffic types, respectively.

According to any one of the above-described aspects of the present disclosure, combination of an SVM and a SOM is used to accurately classify and distinguish traffic, and, thus, it is possible to provide a DDoS detection system capable of producing a more accurate result and reducing a processing time. That is, the SVM is a supervised learning model for identifying a pattern and analyzing data and the SOM is a model for more effectively classifying a flow when it is difficult to classify the flow. Therefore, the advantages of both the SVM and the SOM can be applied to DDoS detection.

Further, according to any one of the above-described aspects of the present disclosure, the combination of the SVM and the SOM is used to detect traffic in a SDN environment, and, thus, it is possible to accurately distinguish a DDoS from normal traffic and also possible to rapidly respond to a defined DDoS type and thus it is possible to effectively prevent and suppress a DDoS. That is, a new perspective on a DDoS in the SDN environment can be defined and typical types of DDoS in an ordinary network can be discovered. Further, it is possible to provide a hybrid flow-based mechanism for reducing effects of a DDoS and it is also possible to defend an OpenFlow controller and an OpenFlow switch against overload.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a configuration diagram of a SDN system to which an exemplary embodiment of the present disclosure is applied.

FIG. 2 is a configuration diagram of an OpenFlow controller in which a DDoS detection system based on SVM-SOM combination is implemented according to an exemplary embodiment of the present disclosure.

FIG. 3 is a flowchart provided to explain a method of DDoS detection based on SVM-SOM combination according to an exemplary embodiment of the present disclosure.

### DETAILED DESCRIPTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, it is to be understood that the term “comprises or includes” and/or “comprising or including” used in the document means that one or more other components, steps, operation and/or existence or addition of elements are not excluded in addition to the described components, steps, operation and/or elements unless context dictates otherwise and is not intended to preclude the possibility that one or more other features, numbers, steps, operations, components, parts, or combinations thereof may exist or may be added.

Through the whole document, the term “unit” or “module” includes a unit implemented by hardware or software and a unit implemented by both of them. One unit may be implemented by two or more pieces of hardware, and two or more units may be implemented by one piece of hardware. However, the “unit” or “module” is not limited to the software or the hardware and may be stored in an addressable storage medium or may be configured to implement one or more processors. Accordingly, the “unit” or “module” may include, for example, software, object-oriented software, classes, tasks, processes, functions, attributes, procedures, sub-routines, segments of program codes, drivers, firmware, micro codes, circuits, data, database, data structures, tables, arrays, variables and the like. The components and functions of the “unit” (or “module”) can be combined with each other or can be divided up into additional components and “units” (or “modules”). Further, the components and the “units” (or “modules”) may be configured to implement one or more CPUs in a device or a secure multimedia card.

A “user device” to be described below may be implemented with computers or portable devices which can access a server or another device through a network. Herein, the computers may include, for example, a notebook, a desktop, and a laptop equipped with a WEB browser. Further, the portable devices are wireless communication devices that ensure portability and mobility and may include all kinds of handheld-based wireless communication devices such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), Wibro (Wireless Broadband Internet) device, and the like. Further, the network may be implemented as wired networks such as a Local Area Network (LAN), a Wide Area Network (WAN) or a Value Added Network (VAN) or all kinds of wireless networks such as a mobile radio communication network or a satellite communication network.

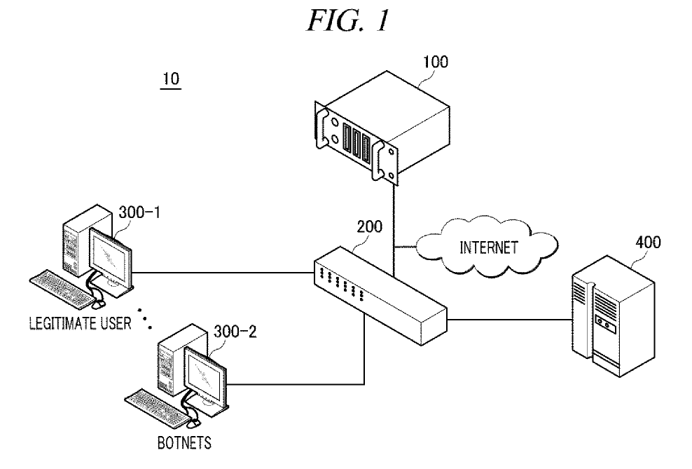

FIG. 1 is a configuration diagram of a SDN system to which an exemplary embodiment of the present disclosure is applied.

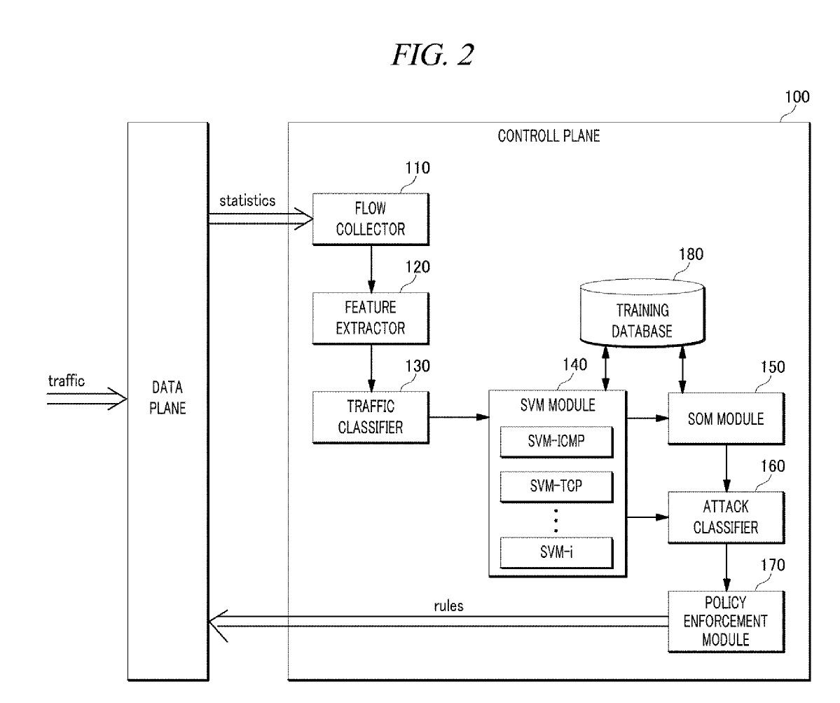

FIG. 2 is a configuration diagram of an OpenFlow controller in which a DDoS detection system based on SVM-SOM combination is implemented according to an exemplary embodiment of the present disclosure.

As illustrated in FIG. 1, a SDN system 10 includes an OpenFlow controller 100 configured to control devices (e.g., one or more OpenFlow switches) on a Software-Defined Network (SDN) according to predetermined communication policies, an OpenFlow switch 200 configured to process transmission/reception of a packet while communicating with each of one or more controllers 100, and user devices 300-1 and 300-2 configured to transmit/receive a packet with a service server 400 through the OpenFlow switch 200. In this case, a SVM-SOM combination-based DDoS detection system according to an exemplary embodiment of the present disclosure can be implemented on the OpenFlow controller 100 as a flow-based handler in a SDN environment.

For reference, the OpenFlow controller 100 and the OpenFlow switch 200 perform communication using an OpenFlow protocol. The OpenFlow protocol is a standard communication interface defined between a control plane and a data plane in the SDN and enables direct control of packet transmission of network devices such as a switch or a router.

When a packet is generated from the user devices 300-1 and 300-2, the OpenFlow switch 200 identifies whether there is information about the packet in a flow-table, and if there is information about the packet in the flow-table, the OpenFlow switch 200 processes the packet according to the identified information. If there is no information about the packet in the flow-table, the OpenFlow switch 200 requests control information about the packet from the OpenFlow controller 100.

The OpenFlow controller 100 requested to supply the control information about the packet by the OpenFlow switch 200 checks packet control information present therein and transmits a result thereof to the OpenFlow switch 200. Then, the control information newly transmitted to the OpenFlow switch 200 is stored in the flow-table and is then applied to the same packet thereafter. In this case, the packet control information in the OpenFlow controller 100 can be input from the outside through an application programming interface (API).

Meanwhile, the SVM-SOM combination-based DDoS detection system implemented on the OpenFlow controller 100 uses a combination of two classification algorithms, i.e., SVM (Support Vector Machine) and SOM (Self-organizing Map), to improve network traffic classification performance. The SVM takes less time to produce an output with high accuracy, and the SOM performs reliable prediction based on its own nerves. Thus, the SVM-SOM combination-based DDoS detection system can protect network components against resource depletion and detect a DDoS in the SDN environment.

Specifically, as illustrated in FIG. 2, the OpenFlow controller 100 includes a flow collector 110, a feature extractor 120, a traffic classifier 130, an SVM module 140, a SOM module 150, an attack classifier 160, a policy enforcement module 170, and a training database 180.

Herein, the SVM module 140 and the SOM module 150 already learn a data set stored in the training database 180 before performing a DDoS attack detection process.

The flow collector 110 collects flow information of traffic (traffic of the user devices 300-1 and 300-2) input from the OpenFlow switch 200 on the data plane side. In this case, the flow collector 110 collects flow information of traffic of all user devices on the SDN system 10. As illustrated in FIG. 1, the SDN system 10 may include not only a legitimate user 300-1 but also a botnet 300-2 that carries out a DDoS attack. That is, the flow collector 110 may also collect flow information of abnormal traffic through the OpenFlow switch 200.

The flow collector 110 sends a flow information request message to the OpenFlow switch 200 at a predetermined time and receives a flow information response message from the OpenFlow switch 200. In this case, the flow collector 110 receives response messages about predetermined four attributes. The flow information request message and the flow information response message may be a “StartsRequest” message and a “StartsResponse” message, respectively, used in the OpenFlow protocol.

Further, the flow collector 110 transmits the collected flow information to the feature extractor 120.

The feature extractor 120 extracts attributes for each flow corresponding the collected flow information and transmits the attributes to the traffic classifier 130.

In this case, the feature extractor 120 extracts flow information about the predetermined four attributes from the response message. Two attributes of the flow information extracted by the feature extractor 120 may be input into the SVM module 140 and the four attributes may be input into the SOM module 150.

The traffic classifier 130 classifies a traffic type of the flow on the basis of the extracted flow attributes and transmits flow information corresponding to the classified flow to the SVM module 140 corresponding to the traffic type.

In this case, the traffic classifier 130 transmits the flow information to an SVM-i corresponding to the flow attributes among multiple SVM-i included in the SVM module 140. For example, flow information corresponding to a flow “protocol ICMP” is transmitted to an SVM-ICMP among the multiple SVM-i illustrated in FIG. 2.

The SVM module 140 identifies (or classifies) a traffic type of the received flow and precisely classifies attack traffic.

In this case, if it is not certain whether the traffic classified by the traffic classifier 130 is attack traffic, the SVM module 140 transmits the flow information to the SOM module 150. Then, the SOM module 150 accurately distinguishes whether the received traffic is attack traffic and then classifies the traffic.

For reference, an SVM algorithm applied to the SVM module 140 according to an exemplary embodiment of the present disclosure will be described in more detail.

The SVM is based on “structural risk minimization principle” for minimizing the classification error probability about data having a fixed but unknown probability distribution. Further, the SVM maps a pattern into a high-dimensional feature space and performs globally optimal discrimination. The SVM finds a hyperplane with the greatest margin from classification data in an input space and performs binary classification.

The SVM module 140 is configured as multiple linear SVM classifiers including multiple SVM-i capable of classifying the kind of network traffic. For example, as illustrated in FIG. 2, the SVM-i may be defined as a classifier capable of classifying the kind of network traffic, such as Internet Control Message Protocol (ICMP), Transmission Control Protocol (TCP), User Datagram Protocol (UDP), and the like.

The SVM-i learns both normal and abnormal sample data (i.e., sample data stored in the training database 180) and after the completion of the learning, the SVM-i generates a data distribution graph and defines a hyperplane. In this case, each SVM-i determines an area at a position satisfying the conditions of the flow on Support Vector Machine representation. If a position of the input flow is in the area corresponding to a clear attack, the SVM module 140 immediately transmits the flow to the attack classifier 160. If not, the SVM module 140 checks whether the position of the flow is in an uncertain area. That is, the SVM module 140 checks whether the flow is clearly determined as a non-attack or it is not certain whether the flow is an attack. As a result of the check, if it is not certain whether an area of the input flow is an attack, the SVM module 140 transmits the flow to the SOM module 150.

The SOM module 150 predicts a position of the input flow on a preset map and classifies an abnormal flow. Further, if the input flow is classified as an abnormal flow, the SOM module 150 regards the input flow as an attack flow and transmits the input flow to the attack classifier 160. As such, a clear attack flow is classified by the SVM module 140, and if it is not certain that there is an attack, an abnormal flow is classified by the SOM module 150. Thus, it is possible to more rapidly and accurately classify DDoS traffic and it is thus possible to prevent and suppress a DDoS.

The SOM module 150 carries out learning according to a SOM (Self-organizing Map) algorithm. The map of the SOM module 150 can be generated by a learning process using prepared data (i.e., sample data stored in the training database 180).

The SOM module 150 defines the classification of suspicious patterns on the basis of weight calculation of the SOM and determines whether an input vector of the input flow is a suspicious pattern on the basis of predetermined tuples. In this case, the input vector input into the SOM module 150 is specified by four tuples (e.g., number of packet, number of byte, duration, and protocol) including predetermined four attributes. An output of the SOM module 150 indicates a final classification result about a suspicious flow (i.e., a flow in an uncertain area in the SVM-i).

For reference, a SOM algorithm applied to the SOM module 150 according to an exemplary embodiment of the present disclosure will be described in more detail.

The SOM (Self-Organizing Map) algorithm refers to data mining technique of unsupervised learning without any teaching. In this case, SOM learning is one of unsupervised learning examples based on an artificial neural network, and the weight of an input vector is adjusted to be equal to a training set. In this case, according to a winner-take-all rule as a kind of competitive network mechanism, a node having a weight vector closest to the input vector is declared the winner and the weight is adjusted to make its value closer to the input vector.

Therefore, the data (i.e., flow) input into the SOM module 150 are reorganized and mapped into the map or a space called node grid. In this case, the input data are usually high-dimensional data and the SOM can transform the high-dimensional data into lower-dimensional data and then visualize the data. In the SOM learning, a similar input pattern affects an adjacent region in the map (or node grid).

Specifically, when the SOM module 150 carries out learning, a vector for each node in the map is initialized to a random or fixed value. Further, when an input vector (i.e., input vector of the flow) is input, Euclidean distances of all the nodes in the map are calculated. In this case, a node closest in distance to the input becomes a Best Matching Unit (BMU), and the neighborhood radius of the BMU is calculated and then gradually decreased every hour.

In this case, a vector of each neighbor node is adjusted to be similar to the input vector according to the following Equation 1.

W(t+1)=W(t)+L(t)*Θ(t)*(V(t)−W(t) [Equation 1]

In Equation 1, L(t) denotes a learning rate that needs to shrink gradually over time. Further, Θ(t) denotes the amount of influence of a relative distance from the BMU on learning. In this case, as a node is closer to the BMU, the influence of a vector is increased.

Then, the process after the input vector is input is repeated.

As compared with other classification algorithms, the SOM algorithm has high accuracy. This is because the SOM classifier classifies not only the input vector but also neighboring vectors.

According to the above description, multiple linear SVM modules 140 acquire flow entries present in flow-tables from the OpenFlow switches 200 and then classify the flows. In this case, if a position of an input flow is in a vague region on the Linear SVM representation or between two margin lines, the input flow is transmitted to the SOM module 150 for more accurate determination. That is, in order to use combination of the SVM and the SOM for network traffic classification, a vague region and suspicious points are defined. The points defined as suspicious are processed by the SOM. As compared with the linear SVM, the input vector in the SOM map has more attributes. Therefore, the SOM can perform a reliable prediction about a suspicious point.

Meanwhile, the attack classifier 160 and the policy enforcement module 170 perform a process to an attack flow in order to reduce attacks and protect the OpenFlow controller 100.

The attack classifier 160 classifies an attack flow of the same type as a DDoS flow and transmits information of the classified attack flow to the policy enforcement module 170.

For example, in an exemplary embodiment of the present disclosure, the attack classifier 160 will be described as classifying two types of attack flows. However, the types and number of attacks to be classified by the attack classifier 160 are not limited.

Specifically, the attack classifier 160 receives information about attack flows from each of the SVM modules 140 and the SOM module 150 and then classifies the abnormal flows into two types on the basis of the protocol. For example, the attack classifier 160 may classify DDoS attacks which may occur in the network into bandwidth depletion attacks and resource depletion attacks.

In a bandwidth depletion attack, an attacker sends traffic that depletes the bandwidth of a victim's network to the victim and thus suppresses access of normal traffic to the victim's network. The bandwidth depletion attack is based on the volume of packets or data coming from a source address. Examples of the bandwidth depletion attack include UDP flooding, ICMP flooding, Smurf, and Fraggle attacks.

In a resource depletion attack, an attacker sends malformed IP packets or a misuse network protocol to a victim and thus depletes resources of the victim. Therefore, even if the access volume is enough, the server itself cannot operate. The resource depletion attack is based on the volume of the number of flows to break down the victim network system, and the attacker generates a large number of flows to a victim address in a short time. Examples of the resource depletion attack include a TCP SYN flooding attack, a UDP flooding attack, a PUSH+ACK attack, and a Malformed Packet attack.

Particularly, the TCP SYN flooding attack refers to an attack used in communication between a sender and a receiver according to a three-handshake protocol before a TCP connection starts. In the TCP SYN flooding attack, an attacker with a malformed IP address sends thousands of requests to a target web server. This attack causes a failure not only in the victim server but also in network devices such as an OpenFlow controller and an OpenFlow switch.

The policy enforcement module 170 establishes a policy for each of predetermined attack types and sends rules with the purpose of attack diminution for the respective types of attack flows classified by the attack classifier 160 to the OpenFlow switch 200.

In order to reduce and suppress the damaging effects of a DDoS, the policy enforcement module 170 establishes policies employing various defense techniques for the respective attack types.

For example, if there is an attack such as an ICMP Flooding attack in which one or two flows are intended to be generated from a client but a huge number of packets are transmitted or there is an attack such as a TCP SYN Flooding attack in which a massive number of flows are generated to a victim server, after a classification process is finished, the policy enforcement module 170 may enforce a policy of removing an abnormal flow from a flow-table. Meanwhile, the policy enforcement module 170 does not add any policy for a normal flow to the flow table.

The operations of the respective components of the SVM-SOM combination-based DDoS detection system may be repeated until there is no more flow information during a predetermined interval time.

The training database 180 stores learning samples for SVM-i and SOM learning. An initial input sample is generated from a prepared dataset, and the input sample may be updated while the SVM-SOM combination-based DDoS detection system is executed.

That is, the training database 180 is continuously updated by attributes of flows collected through an operation loop of the above-described components. Therefore, the SVM module 140 and the SOM module 150 may carry out learning using the updated training database 180 at a predetermined time (e.g., at a time defined by a network manager). As such, the training database 180 keeps up to date and the SVM-SOM combination-based DDoS detection system may be adjusted to be suitable for the attributes of the network.

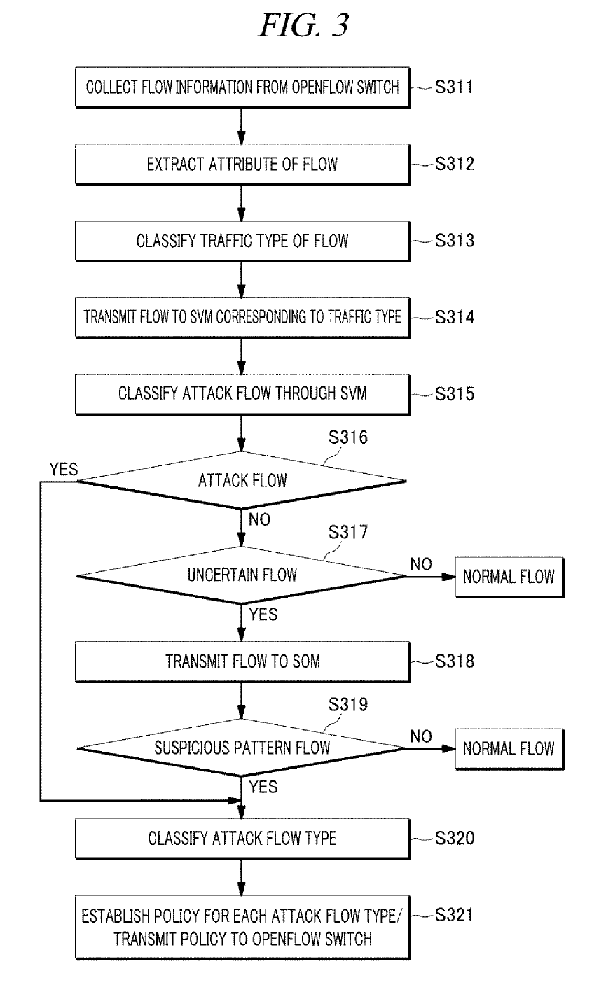

Hereinafter, a method of DDoS attack detection based on SVM-SOM combination according to an exemplary embodiment of the present disclosure will be described in detail with reference to FIG. 3.

FIG. 3 is a flowchart provided to explain a method of DDoS detection based on SVM-SOM combination according to an exemplary embodiment of the present disclosure.

For reference, the SVM-i and the SOM already learn a data set prepared in the training database 180.

Firstly, flow information of traffic is collected from an OpenFlow switch at every predetermined interval time (S311).

Then, predetermined attributes are extracted from the collected flow information (S312).

In this case, the kinds of the extracted attributes may include the number of packet, the number of byte, a duration, and a protocol, but are not limited thereto.

Then, after a traffic type of the flow is classified (S313), the flow is transmitted to an SVM corresponding to the traffic type among multiple SVMs (S314).

An attack flow is classified on the basis of a position of the flow on SVM representation (S315), and it is determined whether the flow is certainly located at a position of a previously learned attack flow (S316).

In this case, the SVM may classify a position of the flow on the basis of one or more predetermined attributes among the attributes of the flow. For example, the SVM may perform classification on the basis of two attributes among the number of packet, the number of byte, a duration, and a protocol.

As a result of the determination in S316, if the position of the flow is not the position of the attack flow, it is determined whether the position of the flow is a suspicious position (S317).

In this case, if the position of the flow is in a vague region on the Linear SVM representation or between two margin lines, the flow is determined to be a suspicious flow and then transmitted to the SOM (S318). Meanwhile, if the position of the flow is certain, the flow is determined to be a normal flow.

Then, the SOM determines whether the flow determined as a suspicious flow by the SVM is a suspicious pattern on the basis of attributes. The SOM applies additional attributes which are not applied by the SVM and then determines whether the flow is a suspicious pattern (S319).

In this case, the SOM determines whether the flow is an attack flow on the basis of predetermined attributes among the attributes of the flow and applies more kinds of attributes than the SVM. For example, the SOM may classify a suspicious pattern using all of the number of packet, the number of byte, a duration, and a protocol.

If the flow is determined as a suspicious attack pattern by the SOM, the SOM classifies an attack type of the flow (S320). Meanwhile, if the flow does not satisfy the conditions of an attack flow, the flow is determined as a normal flow.

As a result of the determination in S316, if the SVM determines that the flow is certainly located at the position of the attack flow, the SVM immediately performs attack type classification to the flow (S320).

In this case, the attack type of the flow may be classified into any one of predetermined multiple types of DDoS attacks, and may be classified into any one of, e.g., a bandwidth depletion attack and a resource depletion attack.

Then, a rule with the purpose of attack diminution corresponding to an attack type of the flow is generated and then sent to an OpenFlow switch corresponding to the flow (S321).

In this case, the rule with the purpose of DDoS attack diminution for the flow may be stored in a flow-table of the OpenFlow switch and then continuously applied to the same flow thereafter.

The above-described processes may be repeated until there is no more flow information during a predetermined interval time.

Further, while the above-described processes are performed, the SVM and the SOM are trained by applying a result of determination and classification about whether a flow is an attack flow, and, thus, the training database is continuously updated. That is, the SVM and the SOM can be trained using updated training data at every predetermined interval time.

The above-described method of DDoS detection based on SVM-SOM combination according to an exemplary embodiment of the present disclosure can be embodied in a storage medium including instruction codes executable by a computer such as a program module executed by the computer. A computer-readable medium can be any usable medium which can be accessed by the computer and includes all volatile/non-volatile and removable/non-removable media. Further, the computer-readable medium may include all computer storage and communication media. The computer storage medium includes all volatile/non-volatile and removable/non-removable media embodied by a certain method or technology for storing information such as computer-readable instruction code, a data structure, a program module or other data. The communication medium typically includes the computer-readable instruction code, the data structure, the program module, or other data of a modulated data signal such as a carrier wave, or other transmission mechanism, and includes a certain information transmission medium.

The system and method of the present disclosure has been explained in relation to a specific embodiment, but its components or a part or all of its operations can be embodied by using a computer system having general-purpose hardware architecture.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. An OpenFlow controller that performs DDoS (distributed denial of service) attack detection based on SVM (support vector machine)-SOM (self-organizing map) combination in a software-defined network (SDN), the OpenFlow controller comprising:
a flow collector configured to collect flow information from multiple OpenFlow switches;
a feature extractor configured to extract predetermined multiple attributes from a flow corresponding to the flow information;
a traffic classifier configured to classify a traffic type of the flow on basis of the attributes and transmit the flow to an SVM module corresponding to the classified traffic type;
the SVM module configured to classify an attack flow on basis of one or more first attributes among the extracted attributes with respect to the flow input according to the traffic type, determine an area on the basis of a position of the flow input on an SVM representation according to a result of learning of normal and abnormal sample data, and transmit the flow to an attack classifier if the determined area is included in an area of an attack flow or transmit the flow to a SOM module if the determined area is included in an uncertain area;
the SOM module configured to determine whether the flow input from the SVM module is a suspicious pattern on a basis of second attributes greater in number than the first attributes among the extracted attributes and to determine whether there is a suspicious pattern with respect to an input vector of the flow input from the SVM module on the SOM module; and
an attack classifier configured to classify the flow, which is classified as a clear attack flow by the SVM module or determined as a suspicious pattern by the SOM module, as one of predetermined attack types.

2. The OpenFlow controller of claim 1, further comprising:
a policy enforcement module configured to generate a rule with a purpose of attack diminution for each of the classified attack types, and to transmit the generated rule with the purpose of attack diminution to an OpenFlow switch corresponding to the flow which is classified as an attack flow or determined as a suspicious pattern.

3. The OpenFlow controller of claim 1, further comprising:
a training database which stores learning sample data for normal flow learning and abnormal flow learning for the SVM module and the SOM module,
wherein the training database is updated with results of the classifying an attack flow by the SVM module and the determining of the suspicious pattern by the SOM module.

4. The OpenFlow controller of claim 1,
wherein the attack classifier classifies the flow as a bandwidth depletion attack or a resource depletion attack on the basis of a flow protocol.

5. The OpenFlow controller of claim 1,
wherein the multiple attributes include at least one of a number of packet, a number of byte, a duration, and a protocol.

6. The OpenFlow controller of claim 1,
wherein the SVM module includes multiple linear SVMs corresponding to predetermined multiple traffic types, respectively.

7. A method of DDoS (distributed denial of service) attack detection based on SVM (support vector machine)-SOM (self-organizing map) combination by an OpenFlow controller in a software-defined network (SDN), the method comprising:
collecting flow information from multiple OpenFlow switches;
extracting predetermined multiple attributes from a flow corresponding to the flow information;
classifying a traffic type of the flow on the basis of the extracted attributes;
classifying the flow as an attack flow through an SVM on basis of one or more first attributes among the extracted attributes of the flow;
determining the flow as a suspicious pattern through a SOM on basis of second attributes greater in number than the first attributes among the extracted attributes of the flow if the flow is not classified as an attack flow; and
classifying an attack type of the flow as one of predetermined attack types if the flow is classified as a clear attack flow by the SVM or determined as a suspicious pattern by the SOM,
wherein the step of classifying the flow as an attack flow is performed through the SVM corresponding to the classified traffic type among multiple linear SVMs corresponding to predetermined multiple traffic types, respectively.

8. The method of DDoS attack detection based on SVM-SOM combination of claim 7, further comprising:
after the step of classifying of an attack type,
generating a rule with a purpose of attack diminution for the classified attack type and transmitting the generated rule with the purpose of attack diminution to an OpenFlow switch corresponding to the flow which is classified as an attack flow or determined as a suspicious pattern.

9. The method of DDoS attack detection based on SVM-SOM combination of claim 7, further comprising:
before the step of classifying an attack flow,
training the SVM and the SOM using a training database which stores learning sample data for normal flow learning and abnormal flow learning,
wherein the training database is updated with results of the classifying an attack flow by the SVM and the determining of the suspicious pattern by the SOM.

10. The method of DDoS attack detection based on SVM-SOM combination of claim 7,
wherein the multiple attributes include at least one of a number of packet, a number of byte, a duration, and a protocol.

11. The method of DDoS attack detection based on SVM-SOM combination of claim 7,
wherein the step of classifying an attack type includes classifying the flow as a bandwidth depletion attack or a resource depletion attack on the basis of a flow protocol.
